(19) United States
(12) Patent Application Publication
(10) Pub. No.: US 2008/0234610 A1
(43) Pub. Date: Sep. 25, 2008

(54) FACIAL WETTING APPARATUS

(75) Inventor: Neil Summers, Dorking (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ENANEF Limited, Dorking (GB)

(21) Appl. No.: 12/047,150

(22) Filed: Mar. 12, 2008

(30) Foreign Application Priority Data
Mar. 21, 2007 (GB) 0705383.8

(51) Int. Cl. A61H 1/00; A61H 7/00; A61H 33/00

(52) U.S. Cl. 601/46; 601/166; 604/303; 607/82

(57) ABSTRACT

The present invention provides for a facial wetting apparatus having a substantially concave portion generally contoured to receive a user's face therein and including airway means adapted for communication with a user's mouth for breathing purposes, the device further being arranged to present water to the user's face when received in the device and such that the water presentation can continue and in a readily controlled manner without compromising the user's breathing which continues by way of the airway means.

### BACKGROUND OF THE INVENTION

The present invention relates to a facial wetting apparatus. While a wide variety of facial treatments are known and widely available for both medical and therapeutic reasons, the effectiveness of such treatments can depend upon the degree of hydration of the facial skin. It is further recognised that the regular introduction of water to the skin can serve to enhance the treatment or therapy, and can also prove beneficial to the skin in its own right.

However, the manner in which water is generally introduced to the facial skin, typically by the manual splashing of a water supply onto the face, often proves disadvantageously inconvenient and potentially inefficient due to the potentially inconsistent manner in which the water actually contacts the skin.

### BRIEF SUMMARY OF THE INVENTION

The present invention seeks to provide facial wetting apparatus allowing for the presentation of water to a user's face and to provide advantages as compared with current arrangements and procedures for such water-introduction.

According to the present invention there is provided facial wetting apparatus having a substantially concave portion arranged for receiving a user's face and including airway means adapted for communication with a user's mouth for breathing purposes, the apparatus further being arranged to present water to the user's face when received in the apparatus.

The apparatus is advantageous in that through employment of the concave portion in combination with the airway means, an arrangement can be provided that allows for the efficient and accurate introduction of water to a user's face and for any appropriate length of time independent of the breathing requirements of the user.

Preferably, the means for presenting water to the surface of the user's face comprises means for projecting water on to the user's face.

In this manner, the water can be presented to a user in an advantageously controlled manner with regard to, for example, the direction, rate, temperature and volume of water presented.

In particular, the surface of the said substantially concave portion can be provided with a plurality of water-jet apertures.

Yet further, the apparatus can be arranged to retain water within the substantially concave portion so as to allow for at least partial immersion of the user's face therein.

Irrespective of whether or not at least partial immersion of the user's face is required the concave portion of the device can advantageously include drainage apertures in the lower regions thereof and which provide for the escape of water therefrom.

Also, apertures can be provided within the surface of the substantially concave portion through which air can be introduced into the concave portion so as to form bubbles in any water contained therein. Such features can enhance the therapeutic benefits of the apparatus.

As a further advantage, the configuration of the surface defining the concave portion is contoured so as to reflect the general shape of a human face.

In this manner, the concave portion is readily adapted for receipt of the user's face by way of a relatively close fit with the surface of the concave portion.

As such, the surface of the concave portion can be arranged for contact with the user's face and, in particular, the said surface can include a plurality of upstanding surface formations for contact with the user's face.

The configuration and dimensions of such surface formations can vary in accordance with the treatment to the applied to the user's face. In one example, the said surface formations can comprise a plurality of flexible bristles.

Advantageously, the airway means is arranged to be movable relative to the surface of the substantially concave portion so as to allow for ease of use and ready movement of the user's face relative to the apparatus without compromising the airway thereby provided for breathing purposes.

In particular, the airway means can comprise a flexible airway means in the form, for example, a flexible and/or telescopic tube arrangement.

Yet further, the airway means can include a mouthpiece for ready engagement with the user's mouth and which can include bite-tabs for ease, and security, of retention in the user's mouth.

The device can further be arranged so as to include a water reservoir from which the water to be introduced to the user's face is drawn by pump means. As an alternative, the device can include adapter means for the input of water from an external supply.

The apparatus can further comprise temperature control means for controlling the temperature of the water to be presented to the user's face.

In particular, the temperature control means can include heating means.

Yet further, the apparatus can include vibratory means by which the surface of the substantially concave portion can vibrate and/or the water found therein can be agitated.

In particular, if the surface of the substantially concave portion includes the above mentioned surface formations, the vibratory means is advantageously arranged so as to cause the formations to vibrate and/or perform oscillatory motion during contact with the user's face.

The airway means can be arranged to communicate with an on-board air supply or, alternatively, can be arranged to vent to the atmosphere external of the apparatus.

The invention is described further hereinafter by way of example only, with reference to the accompanying drawings in which:

### BRIEF DESCRIPTION OF THE DRAWINGS

FIG. 1 is a plan view of a facial wetting apparatus according to an embodiment of the present invention;

FIG. 2 is a longitudinal cross-section view of the apparatus of FIG. 1;

FIG. 3 is a sectional part view of the apparatus as illustrated in FIG. 2 and focussing on the airway means thereof, and

FIG. 4 is an enlarged part sectional view of the apparatus as illustrated in FIG. 2 and serving to illustrate in further detail the texture of the surface of the concave portion of the apparatus.

### DESCRIPTION OF THE SPECIFIC EMBODIMENTS

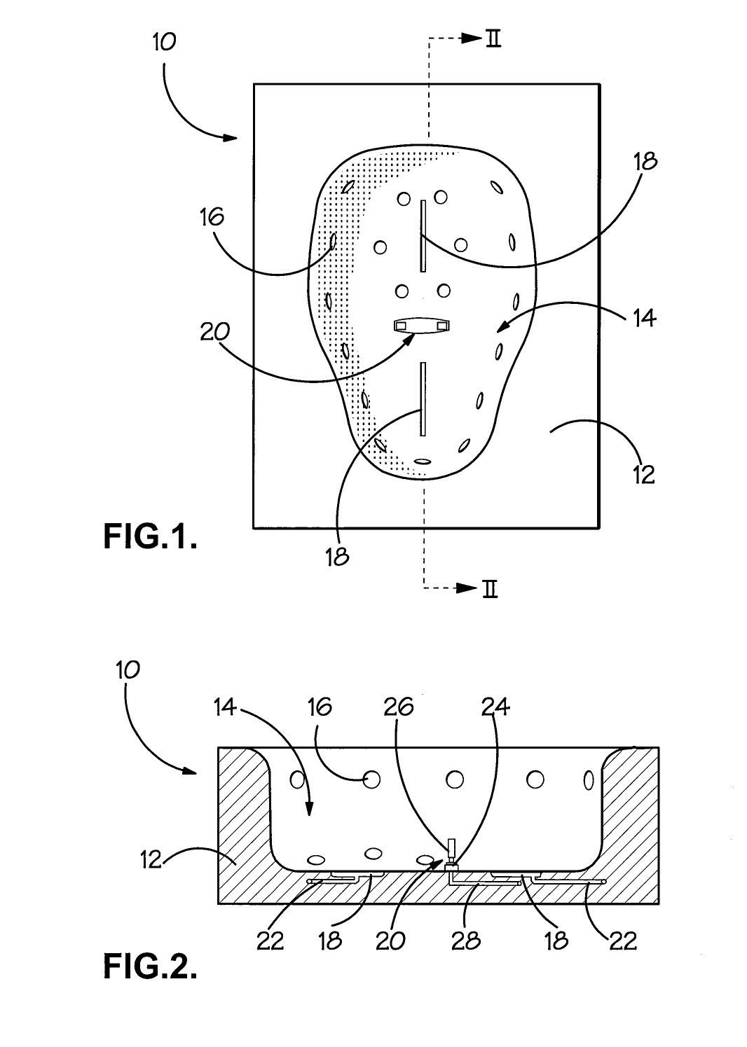

Turning first to FIG. 1, there is provided a plan view of apparatus 10 embodying the present invention and which comprises a rectilinear receptacle body 12 within which is provided a concave face receiving region 14 configured and contoured to reflect the general shape of the human face.

The surface of the receiving region 14 is provided with a plurality of apertures 16 which, within the illustrated embodiment, comprise water-jet nozzles by means of which water can be introduced into the face-receiving concave region 14.

Water introduced into the region 14 in this manner is allowed to escape therefrom by the means of drainage slots 18 provided in the lowermost region of the surface of the region.

Details of the embodiment of the apparatus illustrated in FIG. 1 are illustrated still further with reference to FIG. 2 which comprises a cross-sectional view taken in the direction of Arrows II of FIG. 1.

Also illustrated in the plan view of FIG. 1 is an airway arrangement 20 by means of which a user can safely continue breathing whilst their face is received within the concave region 14 and water is presented thereto.

The location of the water jet nozzles 16 is illustrated further within FIG. 2 as is the general depth to which the concave region 14 extends.

FIG. 2 also illustrates drainage passages 22 in communication with the drainage slots 18 and through which water escapes from the concave region 14 and towards a chamber (not shown) within the apparatus, or by way of a drainage path (also not shown) externally of the apparatus.

As mentioned, the airway means 20 is adapted for ease of breathing by the user and, in the illustrated example, includes a telescopic portion 24 and mouthpiece 26 contiguous with the internal passage presented by the telescopic portion 24.

The airway arrangement 20 includes the telescopic portion 24 so as to readily allow the user to adjust the height of the mouthpiece to assist with the use and/or setting-up of the apparatus.

That is, the height of the telescopic portion 24 will depend upon how far the user wishes to lower their face into the concave region 14 which will have an effect upon the manner in which the water exiting through the water-jet nozzle 16 impacts upon the face.

Also, in an embodiment (not shown) within which no drainage slots 18 are provided, or are at least closed, the region 14 can then serve as a facial-bath arrangement offering a required depth of water into which the face can be at least partly immersed. In this manner, the telescopic portion 24 of the airway 20 can be arranged to be raised above the water level for engagement with the user's mouth prior to at least partial immersion of the user's face into the water found in the receptacle.

As illustrated in FIG. 2, the mouthpiece 26 can include bite-tabs so as to ease the manner and comfort with which the mouthpiece, and thereby the airway, can be securely used by the user and retained in their mouth.

Yet further in FIG. 2, there is illustrated an airway passage 28 extending through the receptacle body 12 and which, in the illustrated embodiment, vents to the atmosphere surrounding the apparatus 10 such that the user then breathes atmospheric air.

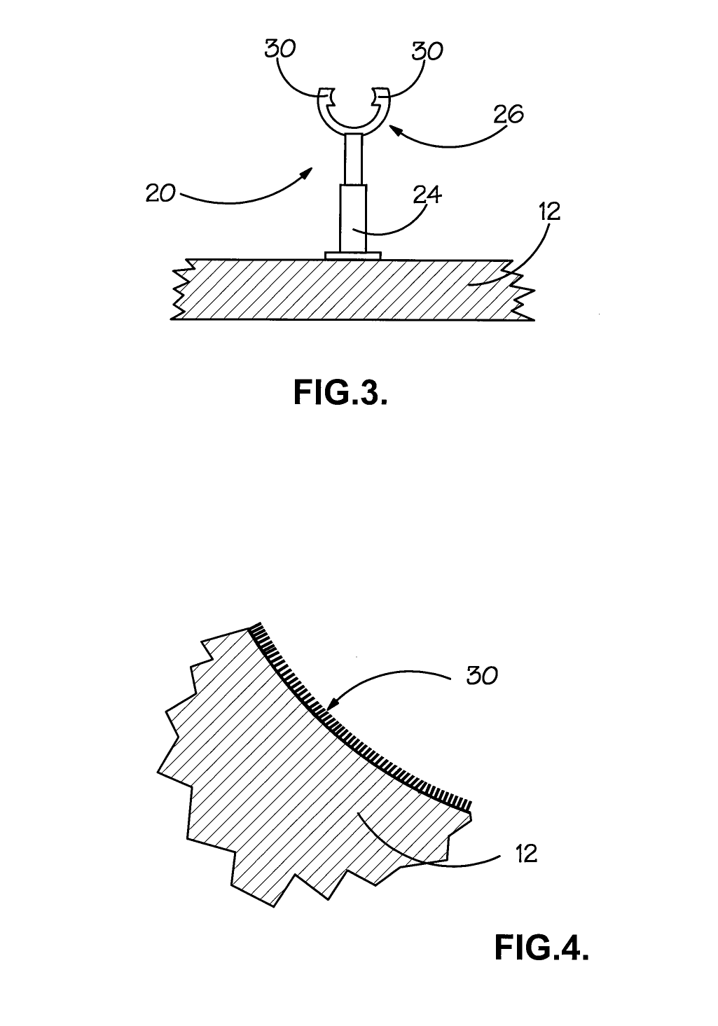

The manner in which the telescopic arrangement of the airway 20 operates is illustrated further by reference to FIG. 3 and which shows the airway 20 with its telescopic portion 24 extended. Also illustrated in FIG. 3 are the bite-tabs 30 provided as part of the mouthpiece 26.

Finally, with regard to FIG. 4, there is illustrated in detail an example of the surface texture of the concave region 14 of FIG. 1. As can be seen, the surface comprises bristles 30 arranged for contact with the skin of a user's face.

Although not illustrated in the embodiment of FIGS. 1-4, the apparatus can include vibratory means by which vibration is imparted to the surface of the concave region 14 so as to cause the bristles 32, if present, to oscillate whilst in contact with the user's face.

Thus, a facial treatment can be provided by the illustrated embodiment of the present invention and can comprise a combination of water-treatment due to the water delivered by way of the water-jets 16, and contact treatment arising from the oscillating bristles 30.

As a further alternative, the surface of the concave region 14 can be provided with apertures through-which air can be introduced as required. In this manner, if water is to be retained within the concave region 14 for the at least partial immersion of the user's face therein, air can be introduced by way of such apertures so as to provide for a supply of continuous bubbles and which can serve further to enhance the treatment offered by way of the apparatus of the present invention.

It should of course be appreciated that the present invention is not restricted to the details of the foregoing embodiment.

For example the apparatus can be provided with any combination of features such as that discussed above and as required.

1. A facial wetting apparatus having a substantially concave portion arranged for receiving a user's face and including airway means adapted for communication with a user's mouth for breathing purposes, the apparatus further being arranged to present water to the user's face when received in the apparatus.

2. Apparatus as claimed in claim 1, wherein the means for presenting water to the surface of a user's face comprises means for projecting water on to the user's face.

3. Apparatus as claimed in claim 2, wherein the surface of the said concave portion is provided with a plurality of water-jet apertures.

4. Apparatus as claimed in claim 1, and arranged to retain water within the concave portion so as to allow for at least partial immersion of the user's face.

5. Apparatus as claimed in claim 1, wherein the concave portion includes drainage apertures in the lower regions thereof so as to allow for the escape of water therefrom.

6. Apparatus as claimed in claim 1, wherein the apertures are provided in the surface of the concave portion through which air can be introduced into the concave portion as required.

7. Apparatus as claimed in claim 1, the surface of the concave portion is contoured so as to reflect the general shape of a human face.

8. Apparatus as claimed in claim 7 wherein the surface of the concave portion is arranged for contact with the user's face.

9. Apparatus as claimed in claim 8, wherein the said surface includes a plurality of surface formations for contact with the user's face.

10. Apparatus as claimed in claim 9, wherein the surface formation comprise bristles.

11. Apparatus as claimed in claim 1, wherein the airway means is arranged to be movable relative to the surface of the substantially concave portion.

12. Apparatus as claimed in claim 11, and comprising a flexible and/or telescopic tube arrangement.

13. Apparatus as claimed in claim 1, wherein the airway means includes a mouthpiece having bite-tabs.

14. Apparatus as claimed in claim 1, and including a water reservoir from which the water to be introduced to the user's face is drawn by pump means.

15. Apparatus as claimed in claim 1, and including temperature control means for controlling the temperature of the water as presented to the user's face.

16. Apparatus as claimed in claim 1, and including vibratory means by which the surface of the substantially concave portion is caused to vibrate and/or water found therein is agitated.
